(19) United States
(12) Patent Application Publication
(10) Pub. No.: US 2014/0324505 A1
(43) Pub. Date: Oct. 30, 2014

(54) Raising User Satisfaction in an Automated Ride Sharing System

(71) Applicants: Vedran LERENC, Schoenau (DE); Jens LEHMANN, Sunnyvale, CA (US); David Sommer, Bruehl (DE)

(72) Inventors: Vedran LERENC, Schoenau (DE); Jens LEHMANN, Sunnyvale, CA (US); David Sommer, Bruehl (DE)

(21) Appl. No.: 14/325,946

(22) Filed: Jul. 8, 2014

Related U.S. Application Data
(62) Division of application No. 13/330,162, filed on Dec. 19, 2011.

(51) Int. Cl. G06Q 10/10; G06Q 50/30

(52) U.S. Cl. CPC G06Q 10/1095; G06Q 50/30
USPC 705/7.19

(57) ABSTRACT

Embodiments of the present invention may provide a various techniques for raising user satisfaction with an automated ride sharing system. In one embodiment, the system may disqualify potential passengers that will force the driver to return to a previously departed area. In another embodiment, the system may consolidate multiple stop locations to reduce the number and frequency of stops in a scheduled ride. In another embodiment, the system may select a best possible ride from a plurality of calculated rides based on user satisfaction factors.

### BACKGROUND

While driving has many benefits, driving has some drawbacks as well. For example, driving can be expensive because of fuel costs, car maintenance, insurance, etc. With the number of vehicles on the road increasing, traffic has also become a significant problem especially in metropolitan areas. Further, vehicles typically emit CO₂, and many localities have enacted CO₂ emissions reduction strategies with a focus on car emissions. Thus, it would be beneficial to reduce the number of vehicles on the road.

“Carpooling” can reduce the number of vehicles on the road. Carpooling is where two or more people ride together in a single vehicle instead of each driving alone in their own individual vehicle. Usually, people carpool with people they already know; however, this is inefficient because people are then restricted to only their personal social network when arranging rides.

In a carpool system that matches possible drivers with possible passengers, user satisfaction is paramount. If any of the users are dissatisfied with the ride, they are unlikely to return to the system. A driver, for instance, may be dissatisfied with the ride if he/she has to return to an already reached location, which brings about the feeling of wasting time and driving around in circles. The number and frequency of the stops to pick-up/drop-off may also affect a driver satisfaction with the scheduled ride.

Therefore, there is a need in the art for an automated ride sharing system that accounts for user satisfaction when matching rides.

### BRIEF DESCRIPTION OF THE DRAWINGS

FIG. 1 is a simplified block diagram a system according to an embodiment of the present invention.

FIG. 2 is a simplified block diagram of a user device according to an embodiment of the present invention.

FIG. 3 is a logic flow diagram of scheduling a ride according to an embodiment of the present invention.

FIG. 4 is a logic flow diagram of scheduling a ride according to an embodiment of the present invention.

FIGS. 5(a)-(g) are exemplary ride diagrams according to embodiments of the present invention.

FIG. 6 is a logic flow diagram of scheduling a ride according to an embodiment of the present invention.

FIGS. 7(a)-(e) are exemplary ride diagrams according to embodiments of the present invention.

FIG. 8 is a logic flow diagram of scheduling a ride according to an embodiment of the present invention.

### DETAILED DESCRIPTION

Embodiments of the present invention may provide a processor-implemented method for arranging a ride. The method may include receiving driver parameters, the driver parameters including driver start and end locations, and receiving passenger parameters, the passenger parameters including passenger start and end locations. The method may also include if the passenger parameters overlap with a previously departed stop location in the ride based on a predefined overlap criterion, disqualify the passenger from the ride; and if the passenger end location does not overlap with a previously departed stop location in the ride based on the predefined overlap criterion, schedule the ride with the driver and the passenger.

Embodiments of the present invention may provide a processor-implemented method for arranging a ride. The method may include extracting stop coordinates of a possible ride and extracting walking parameters of at least one passenger on the possible ride, wherein the walking parameters include a walking threshold. The method may determine if at least two stop coordinates are within the walking threshold of each other, and if at least two stop coordinates are within the walking threshold, consolidating the at least two stop coordinates into one stop coordinate.

Embodiments of the present invention may provide a processor-implemented method for arranging a ride. The method may include based on driver inputted and potential passenger inputted parameters, calculating a plurality of possible ride solutions. The method may also include assigning weights to the plurality of possible ride solutions, wherein the weights are based on factors relating to quality of the ride; ranking the weighted possible ride solutions; and selecting the top ranked possible ride solution for the ride.

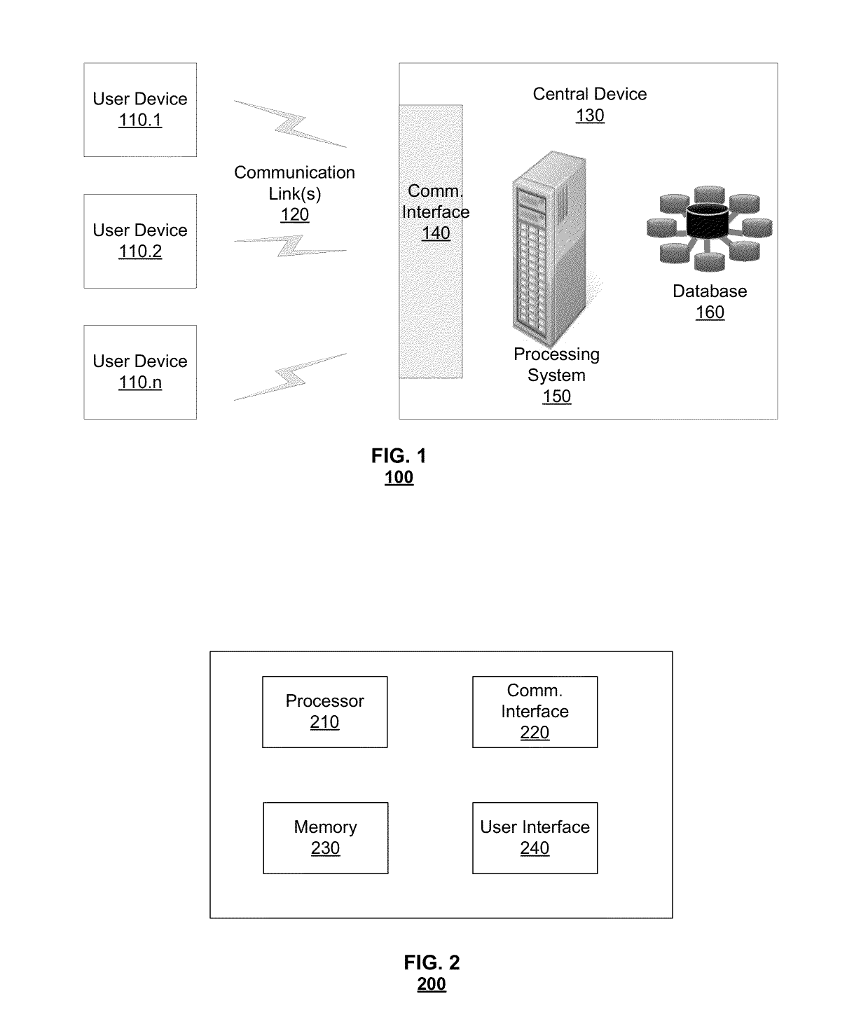

FIG. 1 illustrates a simplified block diagram of an automated ride scheduling system 100 according to an embodiment of the present invention. The system 100 may include a plurality of user devices 110.1-110.n that are communicatively coupled via communication link(s) 120 to a central device 130. The communication link(s) 120 may be provided as a computer network or a wireless network such as a cellular network, WLAN network, short range communication network (i.e. BLUETOOTH®) or a combination of different wired and/or wireless networks. For example, the user device 110.1 may initially communicate with a cellular network then thru an IP network to access the central device 130.

The central device 130 may include a communication interface 140, a processing system 150, and a database 160. The communication interface 140 may be compatible with various networks provided by the communication link(s) 120. The processing system 150 may execute a ride sharing application stored thereon. Information associated with the application may be stored in the database 160. The database 160 may be provided as a single database or a combination of multiple databases.

FIG. 2 illustrates a simplified block diagram of a user device 200 according to an embodiment of the present invention. The user device 200 may include a processor 210, a communication interface 210, a memory 230, and a user interface 240. The user device 200 may be provided as a desktop computer, laptop, tablet, pda, cellular phone, vehicle navigation system, or other suitable devices.

The processor 210 may control the operations of the user device 200. The processor 210 may be any of a plurality of conventional processing systems, including microprocessors, digital signal processors, and field programmable logic arrays.

The communications interface 210 may allow the user device to communicate with the central device. The communications interface may be a wireless internet interface, a wired internet interface, cellular network interface, Bluetooth interface, or any suitable communication protocol interface.

The memory 230 may store program instructions as well as other data, for example, ride sharing application data. Memory 230 may include any combination of conventional memory circuits, including, electrical, magnetic, or optical memory systems. For example, memory 230 may include read only memories, random access memories, and bulk storage.

The user interface 240 may include a display screen and input device. The display screen may be, for example, an LCD screen, a CRT, a plasma screen, an LED screen or the like. The input device may be a keyboard, a mouse, touch screen sensors or any other user input device that would allow a user to interact with the user device 200.

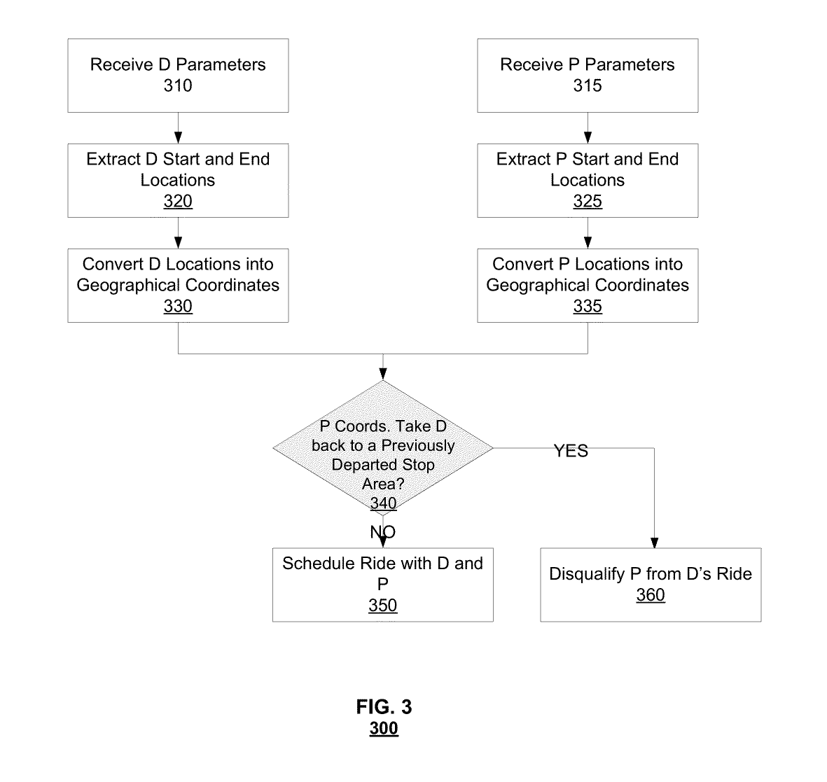

FIG. 3 illustrates a method 300 to automatically schedule a ride in a ride sharing system according to an embodiment of the present invention. The method 300 may be executed on the central device 130 of FIG. 1 as a part of the ride sharing application.

The central device may receive a driver's (D) parameters (step 310). The D parameters may be received from a user device. For example, the driver may input the D parameters into the ride sharing application via a user device. The D parameters may include values representing start location, end location, traveling time, detour time, and other preferences such as social compatibility preferences (e.g., gender, age, occupation). The detour time, for example, may represent the time the driver is willing to prolong his journey in order to pick up and drop off passengers. The D parameters may be stored in the database 160.

D start and end location parameters may be extracted from the database (step 320). The start and end locations, for example, may be saved as street addresses. The start and end locations may then be converted into geographic coordinates (step 330). For example, the addresses of the start and end locations may be converted to geographic coordinates in the form of latitude and longitude coordinates. Alternatively, the addresses may be converted into geographic coordinates and saved in the database in geographic coordinate form.

The central device may also receive a possible passenger (P) parameters (step 315). The P parameters may be received from a user device. For example, the passenger may input the P parameters into the ride sharing application via a user device. The P parameters may include values representing start location (pick up point), end location (drop off point), traveling time, tolerances, and other preferences such as social compatibility preferences (e.g., gender, age, occupation). The tolerances may relate to P specific tolerances for a potential ride such as walking distance threshold, waiting time threshold, etc.

P start and end location parameters may be extracted from the database (step 325). The start and end locations, for example, may be saved as street addresses. The start and end locations may be converted into geographic coordinates (step 335). For example, the addresses of the start and end locations may be converted to geographic coordinates in the form of latitude and longitude coordinates. Alternatively, the addresses may be converted into geographic coordinates and saved in the database in geographic coordinate form.

When scheduling a ride, the method 300 may analyze whether P's coordinates will take the driver back to a previously departed stop area in the proposed ride (step 340). A stop area may be calculated using a predetermined distance from a stop location. Thus, an overlap with a stop location may encompass any point located within a predetermined distance from that stop location, which may be called a stop area. For example, a stop area may be a 1 kilometer area centered around a stop location. In another embodiment, the stop area may be calculated in terms of driving time from a stop location. For example, the stop area may be a 5 minute driving area centered around a stop location. In yet another embodiment, the stop area may be calculated based on real map areas such as neighborhoods, suburbs, boroughs, etc.

If the P coordinates do not take the driver back to a previously departed stop area, the method 300 may schedule the ride with the driver and passenger (step 350). After scheduling the ride, the system may save the scheduled ride and notify the driver and passenger(s) of the scheduled ride.

However, if P coordinates do take the driver back to a previously departed stop area, the method 300 may disqualify the passenger from the driver's ride (step 360). The reason for disqualifying the passenger for the ride even though the proposed ride would not violate the other parameters such as permissible driver detour time is because the proposed ride will make may result in an unpleasant ride for the driver. If the driver has to return to an area where he has already stopped before, the driver may feel like he/she is wasting time and not progressing on his/her journey. Thus, the present invention as described herein consider user satisfaction factors when automatically scheduling shared rides.

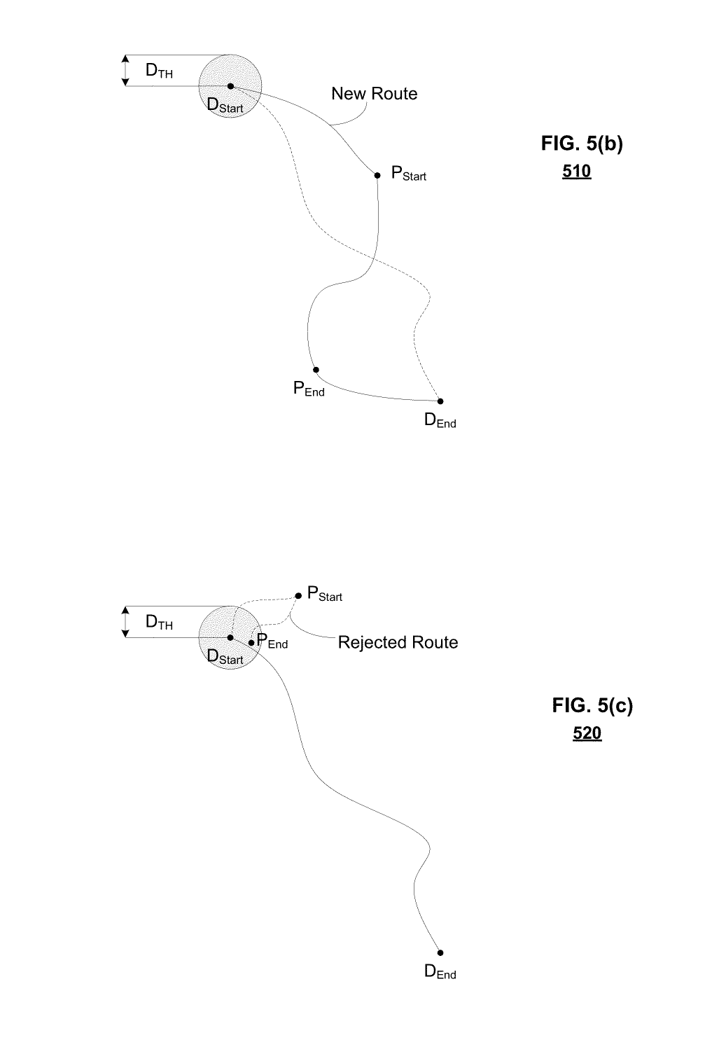

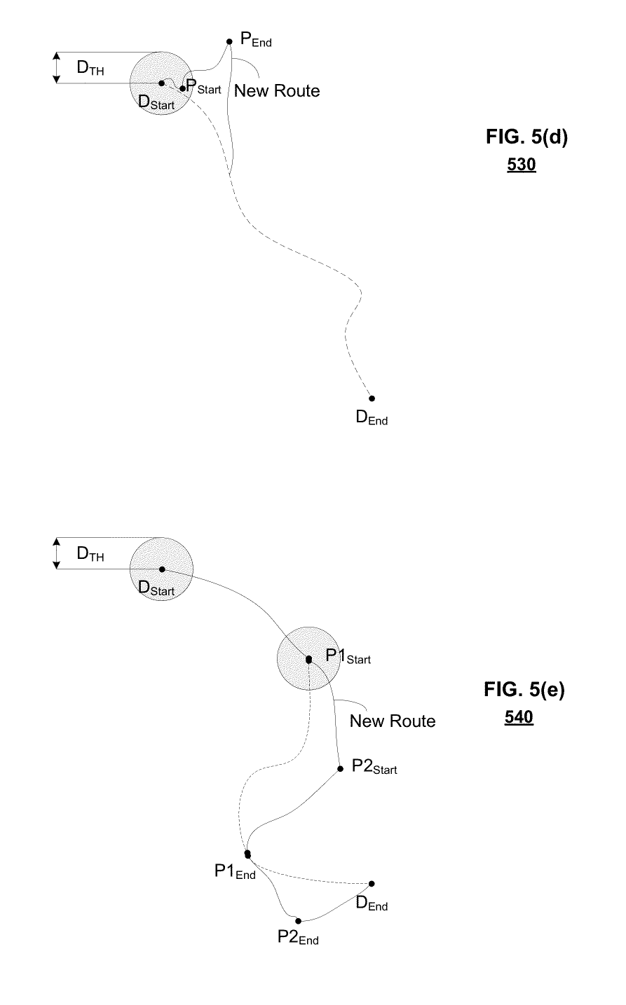

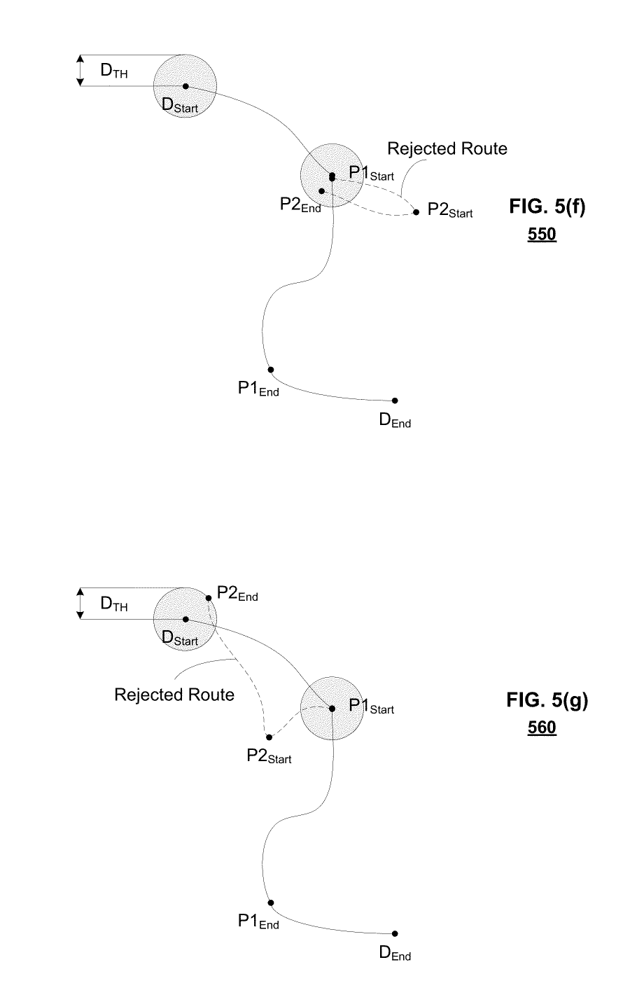

To further illustrate this concept, consider the following ride examples. Ride 500 in FIG. 5(a) may include a D start location, D end location, and a route between the start and end locations. Ride 500 may only provide a ride for the driver with no passengers.

FIG. 5(b), however, illustrates an exemplary ride 510 with a passenger. Ride 510 may include a D start location, D end location, P start location, P end location, and a new route connecting all the locations. In ride 510, the P start and end locations may not force the driver to return to previously departed stop area. For example, when the driver may pick up the passenger at the P_{Start} location, the driver has departed the stop area of his/her own start location D_{Start}. The driver may drop off the passenger at P End without having to return to the stop area of his/her start location, D_{Start}. Thus, ride 510 may be pleasantly received by the driver because the driver may feel like he/she is continuously progressing to his/her end location.

On the other hand, the passenger in ride 520 of FIG. 5(c) may be rejected according to embodiments of the present invention. In ride 520, the passenger's P_{Start} location may be outside the stop area of the driver's D_{Start} location, but the passenger's P End location may be inside the stop area of the driver's D_{Start} location. Thus, ride 520 may first take the driver out of the D_{Start} stop area to pick up the passenger and may take the driver back to the D_{Start} stop area to drop off the passenger. Therefore, the passenger in this case may be disqualified from the ride.

Picking up a passenger in a stop area may not disqualify the passenger from the ride if the driver has not left the stop area. FIG. 5(d) illustrates this scenario. In ride 530, the passenger P_{Start} location may be inside the stop area of the driver's D_{Start} location, and the passenger P_{End} location may be outside the stop area. However, since the driver has not left the stop area before picking up the passenger in the proposed ride, the overlap may not disqualify the passenger from the ride. Furthermore, if the P End location was also inside the stop area of the D_{Start} location, it also may not disqualify the passenger from the ride because the driver again would not have left the stop area before picking up and dropping off the passenger. Thus, the driver may still feel like he/she is continuously progressing on his/her journey.

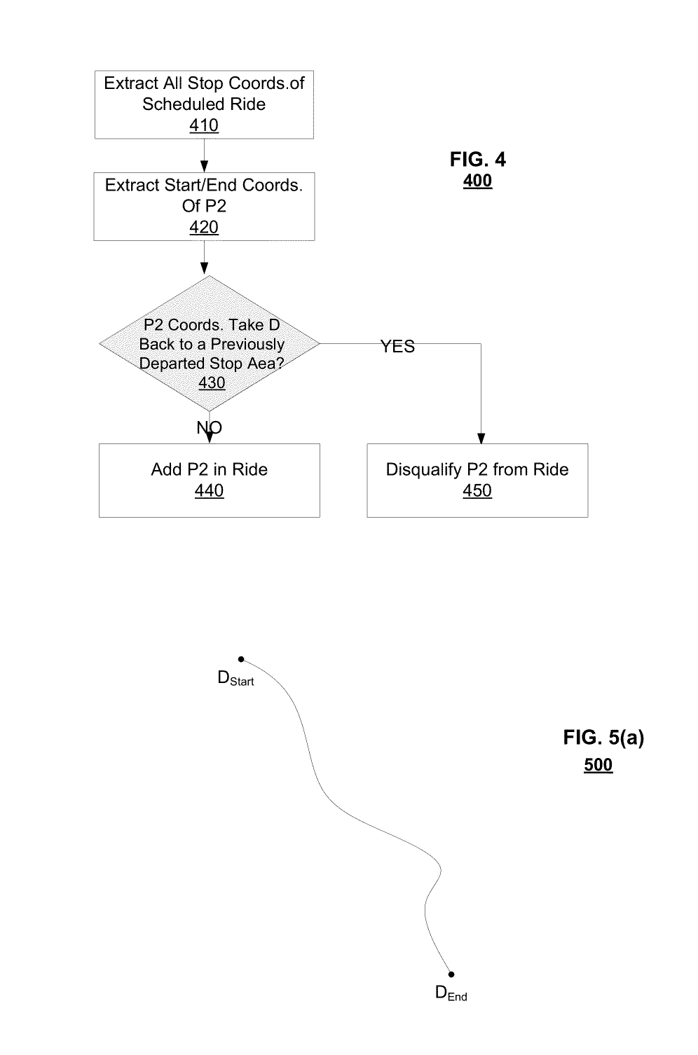

Embodiments of the present invention may also take into account other stop areas along a ride other than the driver's start location such as the pick up and drop off locations of the passengers when scheduling additional passengers. FIG. 4 illustrates a method 400 to automatically schedule a ride with multiple passengers in a carpool scheduling system according to an embodiment of the present invention.

Stop coordinates of a scheduled ride may be extracted as described above (step 410). The stop coordinates may correspond to all points along the scheduled ride including where the driver begins and ends his/her journey, and picks up/drops off passenger(s). Potential additional passenger (P2) start and end coordinates may also be extracted (step 420). The method 400 may then check if P2 stop and end coordinates are located within a previously departed stop area along the ride (step 430). In other words, the method 400 may check if addition of P2 would take the driver back to a previously departed stop area in the ride.

If the P2 coordinates do not take the driver back to a previously departed stop area, the method 400 may add P2 to the ride (step 440). However, if P coordinates do take the driver back to a previously departed stop area, the method 400 may disqualify P2 from the ride (step 450).

To further illustrate this concept, consider the following ride examples. In ride 540 of FIG. 5(e), the system may already have the driver and passenger P1 scheduled and may check to see if additional passenger P2 should be added to the ride. In this example, P2_{Start} and P2_{End} locations do not force the driver to return to a departed stop area, for example the stop areas around D_{Start} or P1_{Start} respectively. Therefore, the system may add P2 to the ride 540, and the ride 540 may be pleasantly received by the driver because he/she may feel like he/she is continuously progressing to his/her end location even with the additional passenger.

In FIG. 5(f), on the other hand, the system may reject the addition of P2 in ride 550 because P2_{End} location may take the driver back to the stop area of P1_{Start} after departing that stop area to pick up P2 at P2_{Start} location. Similarly, in FIG. 5(g), the system may reject the addition of P2 in ride 550 because P2_{End} location may take the driver back to the stop area of D_{Start} after departing that stop area previously in the ride.

The particular ride examples described herein are used for illustrative purpose only, and embodiments of the present invention are not limited to the particular ride examples.

In another embodiment of the present invention, the system may reduce the number of stops a driver makes during a ride by combining pick up/drop off stops if feasible. Having frequent stops may lead to driver dissatisfaction. Therefore, embodiments of the present invention may increase driver satisfaction by minimizing the number and frequency of stops.

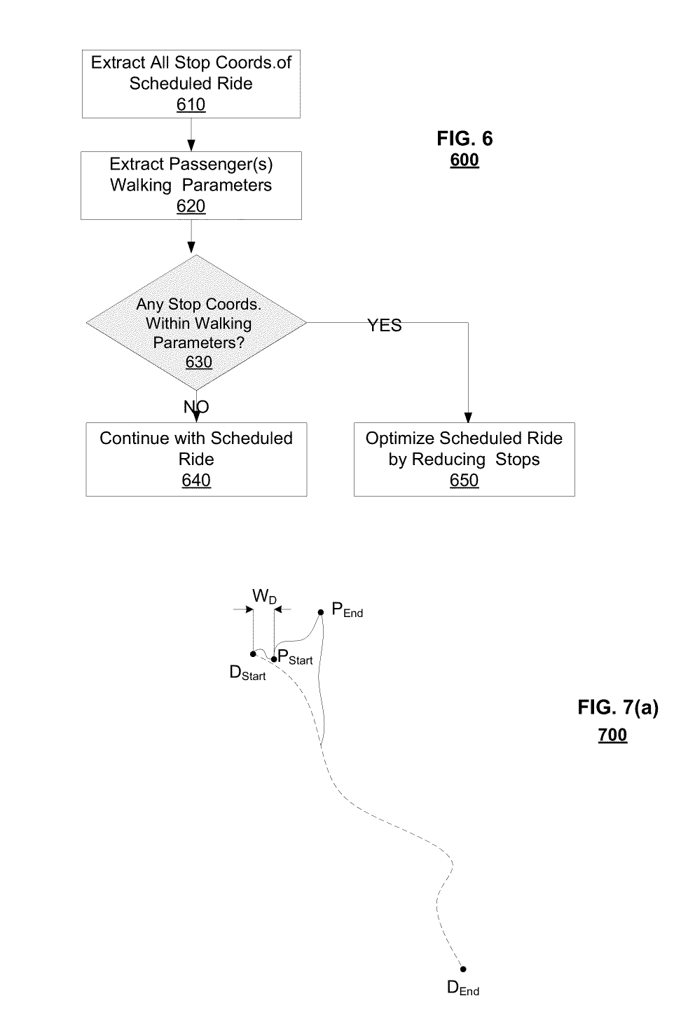

FIG. 6 illustrates a method 600 to automatically schedule a ride with multiple passengers in a carpool scheduling system that reduces the number of stops according to an embodiment of the present invention.

Stop coordinates of a scheduled ride may be extracted as described above (step 610). The stop coordinates may correspond to all points along the scheduled ride including where the driver begins and ends his journey, and picks up and drops off passenger(s).

Walking parameters of the passenger(s) may also be extracted (step 620). The walking parameters may relate to passenger defined walking preferences such as walking distance that a particular passenger is willing to walk to/from a pick up/drop off point. The walking distance may be defined in geographic distance (e.g., 100 meters), in walking time (e.g., 5 minute walk), or in other suitable terms. The walking parameters may be extracted from a passenger user profile or be ride specific parameters.

The method may then check if any stops on the scheduled ride are within the extracted walking parameters (step 630). If no stops are within passenger walking parameters, the method may continue processing of the scheduled ride (step 640). After scheduling the ride, the system may save the scheduled ride and notify the driver and passenger(s) of the scheduled ride.

However, if at least two stops are close enough to be within relevant passenger walking parameters, the method may further optimize the scheduled ride by reducing the number of stops (step 650). The method may consolidate two or more nearby stop locations into one designated stop by moving at least one passenger stop location to another stop location in the ride. As a result, the system may instruct at least one of the passengers to walk to or from the designated stop. In an embodiment, the method may consolidate two or more nearby stop locations by moving the nearby stop locations to a common meeting point location. For example, common meeting points may be pre-defined in the system as known and/or trustworthy pick up/drop off locations. For example, common meeting points may include landmarks, buildings, letter boxes, parking lots, etc.

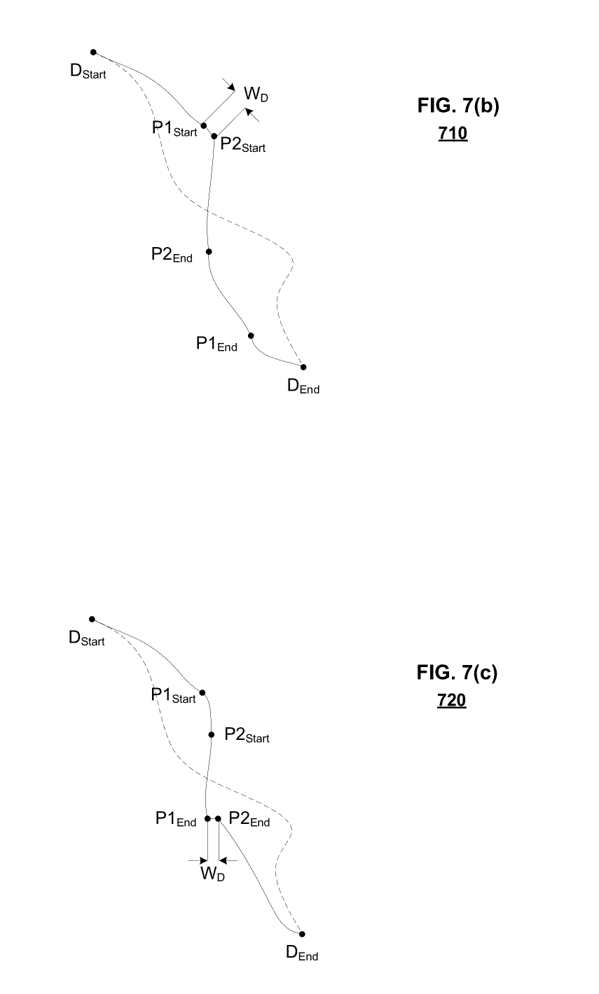

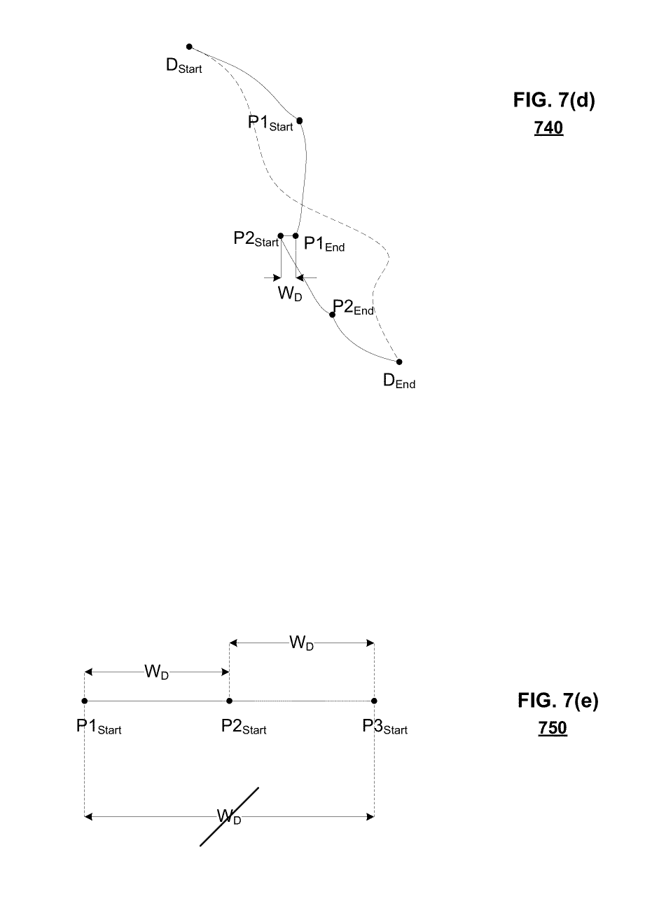

To further illustrate this concept, consider the following ride examples. Ride 700 in FIG. 7(a) may include four stops: D_{Start}, P_{Start}, P_{End}, and D_{End}. However, if the system realizes that locations D_{Start} and P Start are a short distance W_{D} (Walking Distance) apart, for example 100 meters, and passenger parameters indicate that the passenger in this ride is willing to walk, for example 100 meters, the system may combine these two nearby stops into one. The system may optimize the ride by moving the passenger pickup location P_{Start} to the driver start location D_{Start}. Thus, the number of stops in the ride 700 may be reduced from four to three, leading to better driver satisfaction with the system. In an embodiment, a passenger drop off P_{End} location may be moved to a driver end location D_{End} if the locations D_{End} and P End are within W_{D} apart. Various passenger stop location may be moved in different embodiments while maintaining the D_{Start} location as the starting location of the ride and D_{End} location as the ending location of the ride.

FIG. 7(b) illustrates an exemplary ride 710 with two passengers. In ride 710, the stop locations P1_{Start} and P2_{Start} may be a short distance W_{D} apart. Consequently, if the passenger parameters of P1 and P2 permit, the system may combine the two closely located stop locations into one stop location by moving one of the stop locations to the other respective stop location. For example, if P2's walking parameters include a walking threshold distance that is equal to or longer than the walking distance W_{D} between P1_{Start} and P2_{Start} locations, then the system may move P2's start location to P1_{Start}, The system may similarly move P1's start location to P2_{Start} if P1's walking parameters permit such a move. If both passengers walking parameters permit a move of locations, the system may move the later reached location along the ride to the earlier reached location along the ride. Thus, in the ride 710 scenario, if both P1 and P2 walking parameters permit either passengers to move their pick up locations, the system may move P2's pick up locatin to P1_{Start} because P1_{Start} would be the earlier reached location along the ride. In an embodiment where both passengers walking parameters permit a move of locations, the system may move the stop location based on other ride factors such as overall ride time. For example, variables such as one-way street and speed controlled areas may affect overall ride time based on the position of the stop location. Thus, the system may calculate ride times with all possible stop locations, and may select the stop location corresponding to the shortest ride time.

Embodiments of the present invention may also move drop-off locations of passengers to reduce the number of stops if the drop-off locations fit the criteria. In FIG. 7(c), the system may combine the stop locations P1End and P2End based on the passenger walking parameters as described above.

Embodiments of the present invention may also combine pick-up and drop-off locations of different passengers to reduce the number of stops. In FIG. 7(d), the system may combine the stop locations of P1_{End}, a drop-off location, and P2_{Start}, a pick-up location, based on the passenger walking parameters as described above.

In another embodiment of the present invention, the system may accommodate many passenger stop locations (i.e., more than two passengers) in close vicinity. FIG. 7(e) illustrates an exemplary scenario of three passenger pick-up locations in close vicinity. In this example, locations P1_{Start} and P2_{Start} may be within a walking distance W_{D} according to P1 and P2 walking parameters, and locations P2_{Start} and P3_{Start} may be within a walking distance Wd according to P2 and P3 walking parameters. However, locations P1_{Start} and P3_{Start} may not be within a walking distance W_{D} according to P1 and P3 walking parameters. In this scenario, the system may move the pick-up locations for the three passengers to the P2_{Start} location. Thus, the system may instruct P1 and P3 to walk to the P2_{Start} location, which will be their new pick up location. Thus, the system, in this example, may reduce the number of stops by combining three different stops into one.

The particular ride examples described herein are used for illustrative purpose only, and embodiments of the present invention are not limited to the particular ride examples.

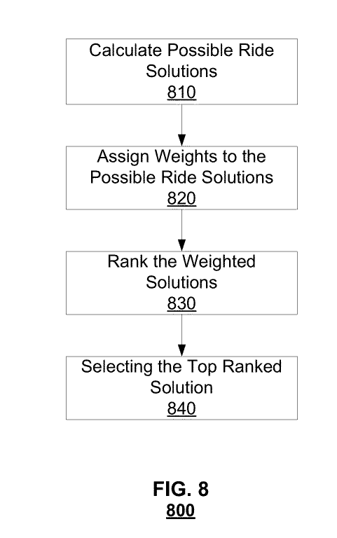

In calculating the best ride, embodiments of the present invention may operate according to a look-ahead algorithm or a weighted algorithm or a combination thereof. FIG. 8 illustrates a method 800 of selecting a best ride according to an embodiment of the present invention. The system may calculate a plurality of possible ride solutions (step 810). The possible ride solutions may be calculated based on driver and potential parameters. The possible ride solutions may also be calculated according to the various techniques of ride scheduling described herein.

After calculating the possible solutions, the system may assign weights to the solutions based on different factors (step 820). The factors may include number of stops, total distance traveled, total length (i.e., ride time), walking distance, walking length, number of passengers, etc. In an embodiment, the system may prioritize minimizing the number of stops first and walking distance/length second. Consequently, the number of stops may be weighted the largest and walking distance/length may be weighted second largest. In another embodiment, the system may prioritize minimizing total ride time.

The system may then rank the weighted solutions (830). The system may select the top ranked solution (840). After selection, the system may save the selected ride and notify the driver and passenger(s) of the selected ride.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

Some embodiments may be implemented, for example, using a computer-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The computer-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

1-20. (canceled)

21. A processor-implemented method for arranging a ride, comprising:
extracting stop coordinates of a possible ride;
extracting walking parameters of at least one passenger on the possible ride, wherein the walking parameters include a walking threshold;
determining if at least two stop coordinates are within the walking threshold of each other;
if at least two stop coordinates are within the walking threshold, consolidating the at least two stop coordinates into one stop coordinate.

22. The processor-implemented method of claim 21, wherein consolidating includes moving a stop coordinate of the at least one passenger to another stop coordinate of the at least two stop coordinates.

23. The processor-implemented method of claim 21, wherein the walking threshold is user defined walking distance.

24. The processor-implemented method of claim 21, wherein the walking threshold is user defined walking time.

25. The processor-implemented method of claim 21, wherein the at least two stop coordinates include a driver start location.

26. The processor-implemented method of claim 21, wherein the at least two stop coordinates include a driver stop location.

27. The processor-implemented method of claim 21, wherein the at least two stop coordinates include a passenger pick-up location.

28. The processor-implemented method of claim 21, wherein the at least two stop coordinates include a passenger drop-off location.

29. A processor-implemented method for arranging a ride, comprising:
based on driver inputted and potential passenger inputted parameters, calculating a plurality of possible ride solutions;
assigning weights to the plurality of possible ride solutions, wherein the weights are based on factors relating to quality of the ride;
ranking the weighted possible ride solutions; and
selecting the top ranked possible ride solution for the ride.

30. The process-implemented method of claim 29, wherein a number of stops is a factor.

31. The process-implemented method of claim 29, wherein walking distance or length is a factor.

32. The process-implemented method of claim 29, wherein overall ride time is a factor.
